(19) United States
(12) Patent Application Publication
(10) Pub. No.: US 2026/0169399 A1
(43) Pub. Date: Jun. 18, 2026

(54) TONER

(71) Applicant: KYOCERA Document Solutions Inc., Osaka (JP)

(72) Inventor: Masaki OKITA, Osaka (JP)

(73) Assignee: KYOCERA Document Solutions Inc., Osaka (JP)

(21) Appl. No.: 19/411,817

(22) Filed: Dec. 8, 2025

(30) Foreign Application Priority Data
Dec. 13, 2024 (JP) 2024-218763

(51) Int. Cl. G03G 9/093; G03G 9/087

(52) U.S. Cl. CPC G03G 9/09321; G03G 9/08755; G03G 9/09371

(57) ABSTRACT

A toner includes a toner particle. The toner particle includes a toner core and a shell layer that covers the surface of the toner core. The toner core contains a binding resin and a colorant. The binding resin includes an amorphous polyester resin and a crystalline polyester resin. The content of the colorant is equal to or greater than 11.5 parts by mass but equal to or less than 17.1 parts by mass with respect to 100.0 parts by mass of the amorphous polyester resin. The area ratio of a region covered by the shell layer to a surface region of the toner core equal to or greater than 30% but equal to or less than 60%.

### INCORPORATION BY REFERENCE

This application is based upon and claims the benefit of priority from the corresponding Japanese Patent Application No. 2024-218763 filed on Dec. 13, 2024, the entire contents of which are incorporated herein by reference.

### BACKGROUND

The present disclosure relates to toners.

In image formation using an image forming apparatus, a toner which can be fixed at a low temperature may be required.

### SUMMARY

A toner according to the present disclosure includes a toner particle. The toner particle includes a toner core and a shell layer that covers the surface of the toner core. The toner core contains a binding resin and a colorant. The binding resin includes an amorphous polyester resin and a crystalline polyester resin. The content of the colorant is equal to or greater than 11.5 parts by mass but equal to or less than 17.1 parts by mass with respect to 100.0 parts by mass of the amorphous polyester resin. The area ratio of a region covered by the shell layer to a surface region of the toner core is equal to or greater than 30% but equal to or less than 60%.

Further features of the present disclosure and specific advantages obtained by the present disclosure will become clearer from the following description of an embodiment.

### BRIEF DESCRIPTION OF THE DRAWINGS

FIG. 1 is a diagram showing an example of the cross-sectional structure of a toner particle in the present disclosure.

### DETAILED DESCRIPTION

Problems in a conventional technology will first be described before the following description of an embodiment in the present disclosure.

In an example of a conventional toner, a toner particle includes: a core particle containing a binding resin; and a shell layer on the surface of the core particle. The shell layer includes a compound containing a nitrogen atom. An external additive includes an organic silicon polymer particle. The difference between the work function Wa of the organic silicon polymer particle and the work function Wb of the toner particle satisfies a formula “0.00 eV<Wa−Wb≤0.75 eV”.

However, in the conventional toner described above, there is room for improvement in low-temperature fixability. Although there is a demand for reducing toner consumption from an environmental perspective, the conventional toner described above is insufficient in the formation of an image with satisfactory color development using a small amount of toner. The conventional toner is also insufficient in hot offset resistance and heat-resistant storage stability.

The embodiment of the present disclosure will be described below. Terms which are used in the present specification will first be described. A toner is an aggregate of toner particles (for example, powder). An external additive is an aggregate of external additive particles (for example, powder). Each of the results of evaluations (values indicating shapes, physical properties and the like) on powder (more specifically, such as the powder of the toner particles or the powder of the external additive particles) is the number average of values obtained by performing a measurement on each of a considerable number of particles selected from the powder unless otherwise specified. Unless otherwise specified, a number average primary particle diameter is the number average value of the circle-equivalent diameters (Heywood diameter: the diameter of a circle having the same area as the projected area of a primary particle) of primary particles measured using a scanning electron microscope. The number average primary particle diameter of powder is, for example, the number average value of the circle-equivalent diameters of 100 primary particles. Unless otherwise specified, the number average primary particle diameter of powder indicates the number average primary particle diameter of particles in the powder. Unless otherwise specified, a volume median diameter (50% cumulative value D₅₀ in a volume-based particle size distribution) is a median diameter measured using a laser diffraction/scattering particle size distribution measuring device (“LA-950” made by HORIBA, Ltd.). A DBP absorption amount is the amount of dibutyl phthalate (DBP) which is absorbed by 100 g of a measurement target, and is measured in accordance with JIS (Japanese Industrial Standards) K6221. In the following description, a compound and its derivative may be collectively referred to by adding the term “-based” to the end of the name of the compound. When the name of a polymer is expressed by adding “-based” to the end of the name of a compound, it means that the repeating unit of the polymer is derived from the compound or its derivative. Acrylic and methacrylic may be collectively referred to as “(meth)acrylic”. Acrylonitrile and methacrylonitrile may be collectively referred to as “(meth)acrylonitrile”. Unless otherwise specified, the “main component” of a material means a component in which the largest amount is included in the material based on mass. Each of components described in the present specification may be used alone or in a combination of two or more thereof. The terms used in the present specification have been described above.

### [Toner]

A toner in the embodiment of the present disclosure will be described below. The toner in the present embodiment includes a toner particle. The toner particle includes a toner core and a shell layer which covers the surface of the toner core. The toner core contains a binding resin and a colorant. The binding resin includes an amorphous polyester resin and a crystalline polyester resin. The content of the colorant is equal to or greater than 11.5 parts by mass but equal to or less than 17.1 parts by mass with respect to 100.0 parts by mass of the amorphous polyester resin. The area ratio of a region covered by the shell layer to a surface region of the toner core is equal to or greater than 30% but equal to or less than 60%.

In the following description, the “area ratio of the region covered by the shell layer to the surface region of the toner core” may be referred to as the “shell layer coverage ratio”.

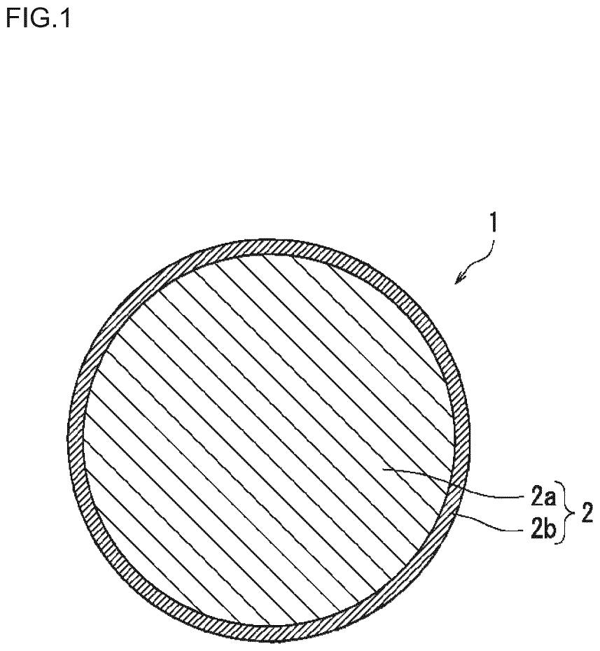

FIG. 1 shows the cross-sectional structure of a toner particle 1. The toner particle 1 is an example of the toner particle included in the toner in the present disclosure. The toner particle 1 includes a toner core 2a and a shell layer 2b which covers the toner core 2a.

The toner in the present embodiment has the configuration described above to be able to form an image of satisfactory color development even with a small amount of toner, and is excellent in low-temperature fixability, hot offset resistance and heat-resistant storage stability. The reason for this is presumed to be as follows.

There is a demand for reducing toner consumption from an environmental perspective. Preferably, in order to form an image of satisfactory color development with a small amount of toner, the content of a colorant per toner particle is increased, and thus color development per toner particle is enhanced. However, since the colorant is unlikely to be melted by heat, when the content of the colorant per toner particle is increased, the low-temperature fixability of the toner tends to be lowered. Hence, it has been found from thorough study that the content of the colorant with respect to 100.0 parts by mass of the amorphous polyester resin affects the elasticity of the toner core and therefore, the elasticity of the toner particle. When the content of the colorant with respect to 100.0 parts by mass of the amorphous polyester resin is equal to or less than 17.1 parts by mass, the toner particle which has elasticity suitable for fixing is obtained, and thus it is possible to suppress an excessive decrease in the low-temperature fixability of the toner. On the other hand, when the content of the colorant with respect to 100.0 parts by mass of the amorphous polyester resin is equal to or greater than 11.5 parts by mass, the color development per toner particle is enhanced, and thus it is possible to form an image with satisfactory color development. Hence, the content of the colorant is set equal to or greater than 11.5 parts by mass but equal to or less than 17.1 parts by mass with respect to 100.0 parts by mass of the amorphous polyester resin, and thus it is possible to achieve both the formation of an image with satisfactory color development using a small amount of toner and the suppression of an excessive decrease in the low-temperature fixability of the toner.

The toner core which contains the amorphous polyester resin and the colorant has appropriate elasticity, and is unlikely to be melted at a low temperature. On the other hand, the shell layer which covers the toner core has high heat resistance, and is unlikely to be melted at a low temperature. When the shell layer coverage ratio is equal to or less than 60%, the toner core is prevented from being excessively covered by the highly heat resistant shell layer, and thus the low-temperature fixability of the toner is enhanced. On the other hand, when the shell layer coverage ratio is equal to or greater than 30%, the toner core is appropriately covered by the highly heat resistant shell layer, and thus the hot offset resistance and heat-resistant storage stability of the toner are enhanced.

The reason why the toner in the present embodiment can form an image of satisfactory color development even with a small amount of toner, and is excellent in low-temperature fixability, hot offset resistance and heat-resistant storage stability has been described.

### <Toner Particle>

The toner particle included in the toner includes the toner core and the shell layer. The shell layer covers the surface of the toner core. The surface region of the toner core includes a covered region and an exposed region. The covered region is a region of the surface region of the toner core which is covered by the shell layer. The exposed region is a region of the surface region of the toner core which is not covered by the shell layer and from which the surface of the toner core is exposed. For example, the exposed region is present on the surface region of the toner core to be scattered or in an island-like shape.

As has already been described, the shell layer coverage ratio is equal to or greater than 30% but equal to or less than 60%. In order to enhance the hot offset resistance and heat-resistant storage stability of the toner, the shell layer coverage ratio is preferably equal to or greater than 40%. In order to enhance the low-temperature fixability of the toner, the shell layer coverage ratio is preferably equal to or less than 50%. The shell layer coverage ratio can be measured, for example, by observing toner base particles dyed with ruthenium using a scanning electron microscope and binarizing the obtained reflected electron image. The shell layer coverage ratio can be adjusted, for example, by changing at least one of the type of shell material, the added amount of shell material with respect to the mass of the toner core and the shelling pH.

### <Toner Core>

The toner core included in the toner particle contains the binding resin and the colorant. The toner core may further contain internal additives (for example, a mold release agent and at least one of components other than those described above) as necessary.

As has already been described, the content of the colorant is equal to or greater than 11.5 parts by mass but equal to or less than 17.1 parts by mass with respect to 100.0 parts by mass of the amorphous polyester resin. In order to achieve a balance between the formation of an image with satisfactory color development using a small amount of toner and the enhancement of the low-temperature fixability of the toner, when the colorant is a black colorant, the content of the black colorant is preferably equal to or greater than 14.5 parts by mass but equal to or less than 15.5 parts by mass with respect to 100.0 parts by mass of the amorphous polyester resin. For the same reason, when the colorant is a yellow colorant, the content of the yellow colorant is preferably equal to or greater than 14.5 parts by mass but equal to or less than 15.5 parts by mass with respect to 100.0 parts by mass of the amorphous polyester resin. For the same reason, when the colorant is a magenta colorant, the content of the magenta colorant is preferably equal to or greater than 16.0 parts by mass but equal to or less than 17.0 parts by mass with respect to 100.0 parts by mass of the amorphous polyester resin. For the same reason, when the colorant is a cyan colorant, the content of the cyan colorant is preferably equal to or greater than 11.5 parts by mass but equal to or less than 12.5 parts by mass with respect to 100.0 parts by mass of the amorphous polyester resin.

The content of the colorant with respect to 100.0 parts by mass of the amorphous polyester resin is measured, for example, by the following method. Specifically, using a turbidity meter, the colorant concentration of a THF (tetrahydrofuran) solution of the toner core having a concentration of 0.25 mg/mL is measured. Using a calibration curve, the measured colorant concentration is converted into the mass WC of the colorant contained in 10 mg of the toner core. A TIF-soluble part (corresponding to the amorphous polyester resin) is separated from the toner core by filtration, and its mass is measured. From the measured mass, the mass WRA of the amorphous polyester resin contained in 10 mg of the toner core is determined. Then, the content of the colorant with respect to 100.0 parts by mass of the amorphous polyester resin is determined using a formula “content of colorant=100.0×WC/WRA”. The details of a method for measuring the content of the colorant with respect to 100.0 parts by mass of the amorphous polyester resin will be described later in Examples.

In order to adjust the content of the colorant with respect to 100.0 parts by mass of the amorphous polyester resin to a range equal to or greater than 11.5 parts by mass but equal to or less than 17.1 parts by mass, the colorant concentration measured using the turbidity meter is preferably in the following range. When the colorant is a black colorant, the colorant concentration measured using the turbidity meter is preferably equal to or greater than 5000 but equal to or less than 6000. When the colorant is a yellow colorant, the colorant concentration measured using the turbidity meter is preferably equal to or greater than 850 but equal to or less than 950. When the colorant is a cyan colorant, the colorant concentration measured using the turbidity meter is preferably equal to or greater than 1500 but equal to or less than 1700. When the colorant is a magenta colorant, the colorant concentration measured using the turbidity meter is preferably equal to or greater than 1250 but equal to or less than 1450.

### (Binding Resin)

The content of the binding resin is preferably equal to or greater than 60% by mass but equal to or less than 95% by mass, and more preferably equal to or greater than 75% by mass but equal to or less than 90% by mass.

As has already been described, the binding resin includes the amorphous polyester resin and the crystalline polyester resin. When the toner core contains, as the binding resin, the crystalline polyester resin and the amorphous polyester resin, the toner having excellent low-temperature fixability can be obtained while the dispersibility of the colorant and the internal additives is being enhanced. The binding resin may further include, as necessary, a resin other than the amorphous polyester resin and the crystalline polyester resin (which may be hereinafter referred to as the other binding resin).

### (Polyester Resin)

The polyester resin is classified into the crystalline polyester resin and the amorphous polyester resin. The crystalline polyester resin has a melting point. The melting point is the temperature of the maximum endothermic peak in an endothermic curve measured using a differential scanning calorimeter. This endothermic peak appears due to the melting of the crystallized portion of the crystalline polyester resin. On the other hand, for the amorphous polyester resin, it is often not possible to measure a clear melting point. Hence, the resin in which a clear endothermic peak cannot be identified in an endothermic curve measured using a differential scanning calorimeter may be determined to be the amorphous polyester resin.

The polyester resin is obtained by condensation polymerization of one or more polyhydric alcohols and one or more polycarboxylic acids. Examples of the polyhydric alcohol for synthesizing the polyester resin include dihydric alcohols (more specifically, aliphatic diol, bisphenol and the like) and trihydric or higher alcohols, as shown below. Examples of the polycarboxylic acid for synthesizing the polyester resin include dicarboxylic acids and tricarboxylic or higher carboxylic acids, as shown below. Instead of the polycarboxylic acid, a polycarboxylic acid derivative capable of forming an ester bond by condensation polymerization (for example, an anhydride of a polycarboxylic acid or a polycarboxylic acid halide) may be used.

Examples of the aliphatic diol serving as an example of the dihydric alcohol include diethylene glycol, triethylene glycol, neopentyl glycol, 1,2-propanediol, α,ω-alkanediols (more specifically, ethylene glycol, 1,3-propanediol, 1,4-butanediol, 1,5-pentanediol, 1,6-hexanediol, 1,7-heptanediol, 1,8-octanediol, 1,9-nonanediol, 1,12-dodecanediol and the like), 2-butene-1,4-diol, 1,4-cyclohexanedimethanol, dipropylene glycol, polyethylene glycol, polypropylene glycol and polytetramethylene glycol.

Examples of the bisphenol serving as an example of the dihydric alcohol include bisphenol A, hydrogenated bisphenol A, bisphenol A ethylene oxide adduct and bisphenol A propylene oxide adduct.

Examples of the trihydric or higher alcohol include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

Examples of the dicarboxylic acid include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acid and alkenyl succinic acid. Examples of alkyl succinic acid include butyl succinic acid, octyl succinic acid and isododecyl succinic acid. Examples of alkenyl succinic acid include butenyl succinic acid, octenyl succinic acid, dodecenyl succinic acid and dodecenyl succinic acid.

Examples of the tricarboxylic or higher carboxylic acid include 1,2,4-benzenetricarboxylic acid (Tri mellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid.

The amorphous polyester resin of the polyester resins will be described below. In one form of the amorphous polyester resin, the amorphous polyester resin is preferably a polymer of at least one bisphenol, at least one dicarboxylic acid and a tricarboxylic acid, more preferably a polymer of at least one alkylene oxide adduct of bisphenol A, alkenyl succinic acid, terephthalic acid and trimellitic acid and further preferably a polymer of a propylene oxide adduct of bisphenol A, an ethylene oxide adduct of bisphenol A, dodecenyl succinic anhydride, terephthalic acid and trimellitic anhydride.

In another form of the amorphous polyester resin, the amorphous polyester resin is preferably a polymer of aliphatic diol and dicarboxylic acid and more preferably a polymer of 1,2-propanediol and adipic acid.

The softening point of the amorphous polyester resin is preferably equal to or greater than 100° C. but equal to or less than 150° C., and more preferably equal to or greater than 120° C. but equal to or less than 130° C. The glass transition point of the amorphous polyester resin is preferably equal to or greater than 50° C. but equal to or less than 130° C. The acid value of the amorphous polyester resin is preferably equal to or greater than 5 mg KOH/g but equal to or less than 20 mg KOH/g. The hydroxyl value of the amorphous polyester resin is preferably equal to or greater than 30 mg KOH/g but equal to or less than 45 mg KOH/g. The mass average molecular weight of the amorphous polyester resin is preferably equal to or greater than 70000 but equal to or less than 110000. The number average molecular weight of the amorphous polyester resin is preferably equal to or greater than 2000 but equal to or less than 5000.

The content of the amorphous polyester resin in the binding resin is preferably equal to or greater than 80.0% by mass but equal to or less than 95.0% by mass, more preferably equal to or greater than 85.0% by mass but equal to or less than 90.0% by mass and further preferably equal to or greater than 87.8% by mass but equal to or less than 88.4% by mass.

The content of the amorphous polyester resin in the toner core is preferably equal to or greater than 65.0% by mass but equal to or less than 90.0% by mass, more preferably equal to or greater than 70.0% by mass but equal to or less than 80.0% by mass and further preferably equal to or greater than 72.3% by mass but equal to or less than 76.3% by mass.

Then, the crystalline polyester resin of the polyester resins will be described below. The crystalline polyester resin is preferably a polymer of at least one aliphatic diol and dicarboxylic acid, more preferably a polymer of at least one α,ω-alkanediol and dicarboxylic acid and further preferably a polymer of 1,4-butanediol, 1,6-hexanediol and fumaric acid or a polymer of ethylene glycol and sebacic acid.

The content of the crystalline polyester resin is preferably equal to or greater than 1.0 part by mass but equal to or less than 30.0 parts by mass with respect to 100.0 parts by mass of the amorphous polyester resin, more preferably equal to or greater than 10.0 parts by mass but equal to or less than 15.0 parts by mass and further preferably equal to or greater than 12.5 parts by mass but equal to or less than 13.5 parts by mass.

The content of the crystalline polyester resin in the binding resin is preferably equal to or greater than 10.0% by mass but equal to or less than 15.0% by mass, more preferably equal to or greater than 11.0% by mass but equal to or less than 12.0% by mass and further preferably equal to or greater than 11.1% by mass but equal to or less than 11.6% by mass.

The content of the crystalline polyester resin in the toner core is preferably equal to or greater than 5.0% by mass but equal to or less than 15.0% by mass, more preferably equal to or greater than 9.0% by mass but equal to or less than 10.0% by mass and further preferably equal to or greater than 9.5% by mass but equal to or less than 9.6% by mass.

The crystalline polyester resin may be contained in the toner core, for example, in a state of a composite resin with the other binding resin. When the polyhydric alcohol or the polycarboxylic acid used to synthesize the crystalline polyester resin has a group (for example, a vinyl group) which can react with a monomer used to synthesize the other binding resin, the crystalline polyester resin and the other binding resin are chemically bonded to form a composite resin. On the other hand, when the polyhydric alcohol or the polycarboxylic acid used to synthesize the crystalline polyester resin does not have a group which can react with a monomer used to synthesize the other binding resin, the crystalline polyester resin and the other binding resin are mixed to form a composite resin.

When the crystalline polyester resin is contained in the toner core in the state of the composite resin with the other binding resin, the softening point of the composite resin is preferably equal to or greater than 70° C. but equal to or less than 100° C., and more preferably equal to or greater than 75° C. but equal to or less than 90° C. The melting point of the composite resin is preferably equal to or greater than 70° C. but equal to or less than 100° C., and more preferably equal to or greater than 75° C. but equal to or less than 85° C. In order for the toner to have an appropriate sharp melting property, the crystallinity index of the composite resin is preferably equal to or greater than 0.90 but equal to or less than 1.2. The crystallinity index of the resin corresponds to the ratio (Tm/Mp) of the softening point (Tm: unit ° C.) to the melting point (Mp: unit ° C.) of the resin.

When the crystalline polyester resin is contained in the toner core in the state of the composite resin with the other binding resin, the acid value of the composite resin is preferably equal to or greater than 1 mg KOH/g but equal to or less than 20 mg KOH/g. The hydroxyl value of the composite resin is preferably equal to or greater than 10 mg KOH/g but equal to or less than 20 mg KOH/g. The mass average molecular weight of the composite resin is preferably equal to or greater than 20000 but equal to or less than 30000. The number average molecular weight of the composite resin is preferably equal to or greater than 2000 but equal to or less than 5000.

### (Other Binding Resin)

The binding resin may include the other binding resin as necessary. In order to enhance the low-temperature fixability of the toner, as the other binding resin, a thermoplastic resin is preferable. Examples of the thermoplastic resin include styrene resin, acrylic resin, polyolefin resin (more specifically, polyethylene resin, polypropylene resin and the like), vinyl resin (more specifically, vinyl chloride resin, polyvinyl alcohol, vinyl ether resin, N-vinyl resin and the like), polyamide resin and urethane resin. Copolymers of these resins, that is, copolymers in which any repeating unit is introduced into the above resins (more specifically, styrene-acrylic resin, styrene-butadiene resin and the like) can also be used as the other binding resin.

In order to obtain the toner which enhances the low-temperature fixability and has excellent charge stability, as the other binding resin, a styrene-acrylic resin is preferable. The styrene-acrylic resin is a polymer of at least one styrene-based monomer and at least one acrylic acid-based monomer.

Examples of the styrene-based monomer which can be used in the polymerization of the styrene-acrylic resin used as the other binding resin include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, p-n-dodecylstyrene, p-hydroxystyrene and 2-(ethoxymethyl)styrene. As the styrene-based monomer which can be used in the polymerization of the styrene-acrylic resin used as the other binding resin, styrene is preferable.

Examples of the acrylic acid-based monomer which can be used in the polymerization of the styrene-acrylic resin used as the other binding resin include (meth)acrylic acid, (meth)acrylic acid alkyl ester and (meth)acrylic acid hydroxyalkyl ester.

Examples of the (meth)acrylic acid alkyl ester include methyl (meth)acrylate, ethyl (meth)acrylate, propyl (meth)acrylate, butyl (meth)acrylate, octyl (meth)acrylate, 2-ethylhexyl (meth)acrylate, stearyl (meth)acrylate and lauryl (meth)acrylate.

Examples of the (meth)acrylic acid hydroxyalkyl ester include 2-hydroxyethyl (meth)acrylate, 3-hydroxypropyl (meth)acrylate, 2-hydroxypropyl (meth)acrylate and 4-hydroxybutyl (meth)acrylate.

As the acrylic acid-based monomer which can be used in the polymerization of the styrene-acrylic resin used as the other binding resin, (meth)acrylic acid alkyl ester is preferable, (meth)acrylic acid alkyl ester in which the number of carbon atoms in an alkyl group is equal to or greater than 1 but equal to or less than 6 is more preferable and butyl (meth)acrylate is further preferable.

As the styrene-acrylic resin, a polymer of styrene and (meth)acrylic acid alkyl ester is preferable, a polymer of styrene and (meth)acrylic acid alkyl ester in which the number of carbon atoms in an alkyl group is equal to or greater than 1 and equal to or less than 6 is more preferable, a polymer of styrene and butyl (meth)acrylate is further preferable and a polymer of styrene and butyl methacrylate is particularly preferable.

When the binding resin includes the other binding resin, the content of the other binding resin is preferably equal to or greater than 0.1 parts by mass but equal to or less than 1.0 part by mass with respect to 100.0 parts by mass of the amorphous polyester resin, and more preferably equal to or greater than 0.5 parts by mass but equal to or less than 0.6 parts by mass.

When the binding resin includes the other binding resin, the content of the other binding resin is preferably equal to or greater than 1.0 part by mass but equal to or less than 10.0 parts by mass with respect to 100.0 parts by mass of the crystalline polyester resin, more preferably equal to or greater than 4.0 parts by mass but equal to or less than 5.5 parts by mass and further preferably equal to or greater than 4.4 parts by mass but equal to or less than 5.1 parts by mass.

When the binding resin includes the other binding resin, the content of the other binding resin in the binding resin is preferably equal to or greater than 0.1 parts by mass but equal to or less than 3.0 parts by mass, more preferably equal to or greater than 0.3 parts by mass but equal to or less than 1.0 part by mass and further preferably equal to or greater than 0.4 parts by mass but equal to or less than 0.6 parts by mass.

When the binding resin includes the other binding resin, the content of the other binding resin in the toner core is preferably equal to or greater than 0.1 parts by mass but equal to or less than 3.0 parts by mass, more preferably equal to or greater than 0.2 parts by mass but equal to or less than 1.0 part by mass and further preferably equal to or greater than 0.3 parts by mass but equal to or less than 0.6 parts by mass.

### (Colorant)

In terms of forming high-quality images using the toner, the content of the colorant is preferably equal to or greater than 1 part by mass but equal to or less than 20 parts by mass with respect to 100 parts by mass of the binding resin, and more preferably equal to or greater than 10 parts by mass but equal to or less than 15 parts by mass. For the same reason, the content of the colorant in the toner core is preferably equal to or greater than 5 parts by mass but equal to or less than 15 parts by mass, and more preferably equal to or greater than 9 parts by mass but equal to or less than 12 parts by mass.

As the colorant, a known pigment or dye can be used according to the color of the toner. Examples of the colorant include a black colorant and a color colorant. Examples of the color colorant include a yellow colorant, a magenta colorant and a cyan colorant.

An example of the black colorant is carbon black. The black colorant may be a colorant which is toned to black using a yellow colorant, a magenta colorant and a cyan colorant.

As the yellow colorant, for example, one or more compounds selected from the group consisting of a condensed azo compound, an isoindolinone compound, an anthraquinone compound, an azo metal complex, a methine compound and an arylamide compound can be used. Examples of the yellow colorant include C. I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191 and 194), Naphthol Yellow S, Hansa Yellow and C. I. Vat Yellow.

As the magenta colorant, for example, one or more compounds selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound and a perylene compound can be used. Examples of the magenta colorant include C. I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221 and 254).

As the cyan colorant, for example, one or more compounds selected from the group consisting of a copper phthalocyanine compound, an anthraquinone compound and a basic dye lake compound can be used. Examples of the cyan colorant include C. I. Pigment Blue (1, 7, 15, 15:1, 15:2, 15:3, 15:4, 60, 62 and 66), Phthalocyanine Blue, C. I. Vat Blue and C. I. Acid Blue.

### (Mold Release Agent)

For example, the mold release agent is used to provide offset resistance to the toner. In terms of providing sufficient offset resistance to the toner, the content of the mold release agent is preferably equal to or greater than 1 part by mass but equal to or less than 20 parts by mass with respect to 100 parts by mass of the binding resin, and more preferably equal to or greater than 5 parts by mass but equal to or less than 10 pars by mass. For the same reason, the content of the mold release agent in the toner core is preferably equal to or greater than 1% by mass but equal to or less than 10% by mass, and more preferably equal to or greater than 3% by mass but equal to or less than 7% by mass.

Examples of the mold release agent include an aliphatic hydrocarbon wax, an oxide of an aliphatic hydrocarbon wax, a vegetable wax, an animal wax, a mineral wax, an ester wax whose main component is a fatty acid ester and a wax in which a fatty acid ester is partially or completely deoxidized. Examples of the aliphatic hydrocarbon wax include low molecular weight polyethylene, low molecular weight polypropylene, a polyolefin copolymer, a polyolefin wax, a microcrystalline wax, a paraffin wax and Fischer-Tropsch wax. Examples of the oxide of the aliphatic hydrocarbon wax include an oxidized polyethylene wax and a block copolymer of the oxidized polyethylene wax. Examples of the vegetable wax include a candelilla wax, a carnauba wax, a Japan wax, a jojoba wax and a rice wax. Examples of the animal wax include a beeswax, lanolin and spermaceti. Examples of the mineral wax include ozokerite, ceresin and petrolatum. Examples of the ester wax whose main component is a fatty acid ester include a montan acid ester wax and a castor wax. Examples of the wax in which a fatty acid ester is partially or completely deoxidized include a deoxidized carnauba wax. As the mold release agent, the ester wax is preferable.

### (Other Components)

Examples of the other components which can be contained in the toner core include a charge control agent, magnetic powder, a compatibilizer and other known additives.

### <Shell Layer>

The shell layer included in the toner particle contains, for example, a resin. The “resin contained in the shell layer” may be hereinafter referred to as the “shell resin”. The shell layer may further contain, as necessary, a component other than the shell resin. In order to obtain the toner suitable for image formation, the thickness of the shell layer is preferably equal to or greater than 1 nm but equal to or less than 400 nm, and more preferably equal to or greater than 5 nm but equal to or less than 50 nm.

### (Shell Resin)

The content of the shell resin in the shell layer is preferably equal to or greater than 90% by mass but equal to or less than 100% by mass, is more preferably equal to or greater than 95% by mass but equal to or less than 100% by mass and is particularly 100% by mass.

Examples of the shell resin include a thermosetting resin, a thermoplastic resin and a mixture of a thermosetting resin and a thermoplastic resin. In order to enhance the low-temperature fixability of the toner, as the shell resin, a thermoplastic resin is preferable. Examples of the thermoplastic resin include a polyester resin, a styrene resin and a styrene acrylic resin. Among them, as the shell resin, the styrene acrylic resin is preferable.

The styrene-acrylic resin is a polymer of at least one styrene-based monomer and at least one acrylic acid-based monomer. For the synthesis of the styrene-acrylic resin, in addition to the styrene-based monomer and the acrylic acid-based monomer, as necessary, a monomer other than them (which may be hereinafter referred to as the other monomer) may be further used.

Examples of the styrene-based monomer and the acrylic acid-based monomer which can be used in the polymerization of the styrene-acrylic resin used as the shell resin include the same ones as the styrene-based monomer and the acrylic acid-based monomer which can be used in the polymerization of the styrene-acrylic resin used as the other binding resin.

When the shell resin includes the styrene-acrylic resin, the content of the styrene-acrylic resin in the shell resin is preferably equal to or greater than 90% by mass but equal to or less than 100% by mass, is more preferably equal to or greater than 95% by mass but equal to or less than 100% by mass and is particularly 100% by mass.

Preferred examples of the styrene-acrylic resin used as the shell resin include a non-cross-linked styrene-acrylic resin, a cross-linked styrene-acrylic resin, a styrene-acrylic resin including a cyano group (CN group) and a styrene-acrylic resin including a quaternary ammonium base.

The shell layer preferably contains two or more resins, and more preferably contains two resins. In other words, the shell resin is preferably two or more resins, and is more preferably two resins. The two or more resins refer to resins having different monomer compositions.

In order to achieve a balance between the enhancement of the low-temperature fixability of the toner and the enhancement of the hot offset resistance and the heat-resistant storage stability of the toner, the shell layer preferably contains a cross-linked styrene-acrylic resin and a non-cross-linked styrene-acrylic resin. The content of the cross-linked styrene-acrylic resin is preferably equal to or greater than 5 parts by mass and equal to or less than 10 pars by mass with respect to 100 parts by mass of the non-cross-linked styrene-acrylic resin.

In order to ensure sufficient positive chargeability of the toner, the shell layer preferably contains a styrene-acrylic resin including a cyano group and a styrene-acrylic resin including a quaternary ammonium base. The content of the styrene-acrylic resin including a quaternary ammonium base is preferably equal to or greater than 5 parts by mass but equal to or less than 10 parts by mass with respect to 100 parts by mass of the styrene-acrylic resin including a cyano group.

The non-cross-linked styrene-acrylic resin, the cross-linked styrene-acrylic resin, the styrene-acrylic resin including a cyano group and the styrene-acrylic resin including a quaternary ammonium base will be further described below.

The non-cross-linked styrene-acrylic resin is a polymer of at least one styrene-based monomer and at least one acrylic acid-based monomer. The non-cross-linked styrene-acrylic resin does not have a cross-linked structure. In other words, the non-cross-linked styrene-acrylic resin does not include a repeating unit derived from a cross-linking agent.

The non-cross-linked styrene-acrylic resin is preferably a polymer of styrene, (meth)acrylic acid alkyl ester and (meth)acrylic acid hydroxyalkyl ester. The non-cross-linked styrene-acrylic resin is more preferably a polymer of styrene, (meth)acrylic acid alkyl ester in which the number of carbon atoms in an alkyl group is equal to or greater than 1 and equal to or less than 6 and (meth)acrylic acid hydroxyalkyl ester in which the number of carbon atoms in an alkyl group is equal to or greater than 1 but equal to or less than 6. The non-cross-linked styrene-acrylic resin is particularly preferably a polymer of styrene, butyl (meth)acrylate and 2-hydroxyethyl (meth)acrylate.

The cross-linked styrene-acrylic resin has a cross-linked structure. The cross-linked styrene-acrylic resin is a polymer of at least one styrene-based monomer, at least one acrylic acid-based monomer and a cross-linking agent. With the cross-linking agent, it is possible to introduce the cross-linked structure into the styrene-acrylic resin. The cross-linking agent is, for example, a cross-linking monomer. As the cross-linking monomer, for example, a compound which has two or more unsaturated bonds (for example, carbon-carbon double bonds) is mentioned, and more specifically, examples thereof include divinylbenzene and diallyl phthalate. Examples of divinylbenzene include o-divinylbenzene, m-divinylbenzene and p-divinylbenzene. Examples of the diallyl phthalate include diallyl isophthalate and diallyl orthophthalate. As the cross-linking agent, divinylbenzene is preferable.

The cross-linked styrene-acrylic resin is preferably a polymer of (meth)acrylic acid alkyl ester, styrene and a compound having two or more unsaturated bonds. The cross-linked styrene-acrylic resin is more preferably a polymer of (meth)acrylic acid alkyl ester in which the number of carbon atoms in an alkyl group is equal to or greater than 1 and equal to or less than 6, styrene and divinylbenzene. The cross-linked styrene-acrylic resin is particularly preferably a polymer of methyl (meth)acrylate, styrene and divinylbenzene.

The styrene-acrylic resin including a cyano group is a polymer of at least one styrene-based monomer, at least one acrylic acid-based monomer and a monomer including a cyano group. As the monomer including a cyano group, for example, (meth)acrylonitrile is mentioned.

The styrene-acrylic resin including a cyano group is preferably a polymer of 2-(ethoxymethyl)styrene, (meth)acrylic acid alkyl ester and (meth)acrylonitrile. The styrene-acrylic resin including a cyano group is more preferably a polymer of 2-(ethoxymethyl)styrene, (meth)acrylic acid alkyl ester in which the number of carbon atoms in an alkyl group is equal to or greater than 1 and equal to or less than 6 and (meth)acrylonitrile. The styrene-acrylic resin including a cyano group is particularly preferably a polymer of 2-(ethoxymethyl)styrene, butyl acrylate and (meth)acrylonitrile.

The styrene-acrylic resin including a quaternary ammonium base is a polymer of at least one styrene-based monomer, at least one acrylic acid-based monomer and a monomer including a quaternary ammonium base. Examples of the monomer including a quaternary ammonium base include vinylbenzyltrialkylammonium salt, 2-(acryloyloxy)ethyltrialkylammonium salt and 2-(methacryloyloxy)ethyltrialkylammonium salt. As the monomer including a quaternary ammonium base, 2-(methacryloyloxy)ethyltrialkylammonium salt is preferable.

Examples of the 2-(methacryloyloxy)ethyltrialkylammonium salt include 2-(methacryloyloxy)ethyltrimethylammonium salt (more specifically, 2-(methacryloyloxy)ethyltrimethylammonium chloride and the like), 2-(methacryloyloxy)ethyldimethylethylammonium salt (more specifically, 2-(methacryloyloxy)ethyldimethylethylammonium chloride and the like) and 2-(methacryloyloxy)ethyldimethyl n-pentylammonium salt (more specifically, 2-(methacryloyloxy)ethyldimethyl n-pentylammonium chloride and the like).

The styrene-acrylic resin including a quaternary ammonium base is preferably a polymer of (meth)acrylic acid alkyl ester, 2-(ethoxymethyl)styrene, (meth)acrylic acid hydroxyalkyl ester and 2-(methacryloyloxy)ethyltrialkylammonium salt. The styrene-acrylic resin including a quaternary ammonium base is more preferably a polymer of (meth)acrylic acid alkyl ester in which the number of carbon atoms in an alkyl group is equal to or greater than 1 but equal to or less than 6, 2-(ethoxymethyl)styrene, (meth)acrylic acid hydroxyalkyl ester in which the number of carbon atoms in an alkyl group is equal to or greater than 1 but equal to or less than 6 and 2-(methacryloyloxy) ethyltrimethylammonium salt. The styrene-acrylic resin including a quaternary ammonium base is particularly preferably a polymer of methyl methacrylate, 2-(ethoxymethyl)styrene, 2-hydroxyethyl methacrylate and 2-(methacryloyloxy)ethyltrimethylammonium chloride.

### (Other Components)

Examples of the other components which can be contained in the shell layer include a pH adjuster, an emulsifier, a charge control agent and other known additives.

### <External Additive>

When the toner particle includes an external additive, as the external additive, for example, an inorganic particle is mentioned, and more specifically, examples thereof include a silica particle and particles of metal oxides (specifically, alumina, titanium oxide, magnesium oxide, zinc oxide, strontium titanate, barium titanate and the like). The surface of the external additive may be subjected to either or both of positive charging treatment and hydrophobic treatment. The content of the external additive is preferably equal to or greater than 0.5 parts by mass but equal to or less than 10.0 parts by mass with respect to 100.0 parts by mass of the toner base particle. The number average primary particle diameter of the external additive is preferably equal to or greater than 5 nm but equal to or less than 80 nm.

### <Method for Manufacturing Toner>

A method for manufacturing the toner in the present embodiment will be described below. The toner in the present embodiment can be manufactured by performing, for example, a toner core formation step and a shell layer formation step. As necessary, after the shell layer formation step, an external addition step may be further performed.

### (Toner Core Formation Step)

In the toner core formation step, the toner core is formed, for example, by an aggregation method or a pulverization method.

The aggregation method includes, for example, an aggregation step and a unification step. In the aggregation step, fine particles including components of the toner core are aggregated in an aqueous medium to form aggregated particles. In the unification step, components included in the aggregated particles are unified in the aqueous medium, and thus the toner core is formed.

The pulverization method will then be described. In the pulverization method, it is possible to relatively easily form the toner core, and thus it is possible to reduce the manufacturing costs. When the pulverization method is used to form the toner core, the toner core formation step includes, for example, a mixing step, a kneading step and a pulverization step. The toner core formation step may further include at least one of a fine pulverization step and a classification step after the pulverization step.

In the mixing step, the binding resin, the colorant and the internal additive which is added as necessary are mixed, and thus a mixture is obtained. In the kneading step, the resulting mixture is kneaded while being melted, and thus a kneaded product is obtained. In the pulverization step, the resulting kneaded product is cooled to, for example, room temperature (25° C.), and is then pulverized, and thus the pulverized product is obtained. When it is necessary to reduce the diameter of the pulverized product obtained in the pulverization step, the pulverized product may be subjected to the fine pulverization step for further pulverizing the pulverized product. When the diameters of the particles of the pulverized product need to be made uniform, the resulting pulverized product may be subjected to the classification step for classifying the resulting pulverized product. The steps described above are performed, and thus the toner core which is the pulverized product is obtained.

### (Shell Layer Formation Step)

In the shell layer formation step, the shell layer is formed on the surface of the toner core. Examples of a method for forming the shell layer include an in-situ polymerization method, a liquid hardening covering method and a coacervation method. As a preferred specific example, the following method is mentioned.

A material for forming the shell layer (which may be hereinafter referred to as the shell material) and the toner core obtained in the toner core formation step are first placed into an aqueous medium. As the shell material, for example, the shell resin is mentioned, and more specifically, the resin particle of the shell resin is mentioned. When the shell material is the resin particle, the aqueous medium including the resin particle and the toner core is heated to facilitate film formation of the resin particle while causing the resin particle to adhere to the surface of the toner core, with the result that the shell layer is formed on the surface of the toner core. In this way, the toner core and the toner base particle which includes the shell layer covering the toner core are obtained.

The temperature (shelling temperature) at which the aqueous medium including the shell material and the toner core is heated is preferably higher than the glass transition point of the shell material. The shelling temperature is preferably equal to or greater than 50° C. but equal to or less than 90° C., and more preferably equal to or greater than 60° C. but equal to or less than 80° C. The time (shelling time) for heating the aqueous medium including the shell material and the toner core is preferably equal to or greater than 0.1 hours but equal to or less than 5.0 hours, and more preferably equal to or greater than 1.0 hour but equal to or less than 3.0 hours. The pH (shelling pH) of the aqueous medium including the shell material and the toner core is preferably equal to or greater than 3 and equal to or less than 5. As the shelling pH is increased, the shell material is less likely to adhere to the toner core, and thus the shell layer coverage ratio tends to be lowered. By contrast, as the shelling pH is lowered, the shell material easily adheres to the toner core, and thus the shell layer coverage ratio tends to be increased.

### (External Addition Step)

In the external addition step, the external additive is adhered to the surface of the toner base particle, and thus the toner particle is obtained. As a method for adhering the external additive to the surface of the toner base particle, for example, a method for stirring the toner base particle and the external additive with a mixer or the like is mentioned.

### EXAMPLES

Although Examples in the present disclosure will be described below, the present disclosure is not limited to the scope of Examples at all. A method for measuring each of physical property values will first be described.

### [Softening Point]

The softening point of a resin was measured using a melt flow tester (“CFT-500D” made by Shimadzu Corporation). In an S-shaped curve (horizontal axis: temperature, vertical axis: stroke) measured with the melt flow tester, the temperature at which “(baseline stroke value+maximum stroke value)/2” was defined as the softening point.

### [Glass Transition Point]

The glass transition point of the resin was measured using a differential scanning calorimeter (“DSC-6220” made by Seiko Instruments Inc.) in accordance with JIS (Japanese Industrial Standards) K7121-2012.

### [Melting Point]

The melting point of the resin was measured using the differential scanning calorimeter (“DSC-6220” made by Seiko Instruments Inc.). The temperature of the maximum endothermic peak in an endothermic curve obtained by the measurement (vertical axis: heat flow (DSC signal), horizontal axis: temperature) was defined as the melting point.

### [Acid Value and Hydroxyl Value]

The acid value and the hydroxyl value of the resin were measured in accordance with JIS (Japanese Industrial Standards) K0070-1992.

### [Mass Average Molecular Weight and Number Average Molecular Weight]

The mass average molecular weight and the number average molecular weight of the resin were measured by gel permeation chromatography (GPC). 10 mg of the resin was first dissolved in 5 mL of tetrahydrofuran (THF) at room temperature for 2 hours, and thus a resin solution was obtained. The resin solution was filtered using a membrane filter (“Pretreatment Disc” made by Tosoh Corporation, membrane pore size of 0.45 m, solvent resistance), and thus a sample solution was obtained. The sample solution was measured under the following GPC measurement conditions using a GPC measurement device (“HLC8120 GPC” made by Tosoh Corporation). Then, the mass average molecular weight and the number average molecular weight of the resin contained in the sample solution were calculated using a molecular weight calibration curve prepared using standard samples of polystyrene resin (“TSK Standard Polystyrene” made by Tosoh Corporation: F-850, F-450, F-288, F-128, F-80, F-40, F-20, F-10, F-4, F-2, F-1, A-5000, A-2500, A-1000 and A-500).

### (GPC Measurement Conditions)

Detector: RI
Column: Shodex (registered trademark) KF-801, 802, 803, 804, 805, 806 and 807 in 7-column unit (made by Showa Denko K.K.)
Eluent: THF
Flow rate: 1.0 mL/minute
Oven temperature: 40.0° C.
Sample solution injection volume: 0.10 mL

### [Amorphous Polyester Resin]

Amorphous polyester resins used to form toner cores were prepared by the following method. The details of the amorphous polyester resins are shown in Table 1 below.

Table 1 is as follows.

TABLE 1

| Amorphous polyester resin | | | RA-A | RA-D |
|---|---|---|---|---|
| Monomer amount | Polyhydric alcohol | BPA-PO | 1700 | — |
| [g] | monomer | BPA-EO | 650 | — |
| | | 1,2-PD | — | 1150 |
| | Polycarboxylic acid | DSA | 200 | — |
| | monomer | TPA | 400 | — |
| | | AA | — | 650 |
| | | TMA | 100 | — |

| | | |
|---|---|---|
| Tm [° C.] | 124.8 | 125.1 |
| Tg [° C.] | 57.2 | 125.3 |
| Acid value [mgKOH/g] | 6.0 | 15.6 |
| Hydroxyl value [mgKOH/g] | 41.0 | 35.1 |
| Mw | 109500 | 79000 |
| Mn | 3800 | 2700 |

Terms used in Table 1 are as follows:
Tm: softening point
Tg: glass transition temperature
Mw: mass average molecular weight
Mn: number average molecular weight
BPA-PO: bisphenol A propylene oxide adduct
BPA-EO: bisphenol A ethylene oxide adduct
1,2-PD: 1,2-propanediol
DSA: dodecenyl succinic anhydride
TPA: terephthalic acid
AA: adipic acid
TMA: trimellitic anhydride
-: corresponding monomer is not used

### <Preparation of Amorphous Polyester Resin (RA-A)>

A four-neck flask including a nitrogen inlet tube, a dehydration tube, a stirrer and a thermocouple was used as a reaction vessel. Monomers shown in the “RA-A” column of Table 1 were placed into the reaction vessel in amounts shown in this column. 4 g of dibutyltin oxide was added to the reaction vessel. The contents of the reaction vessel were reacted at 220° C. for 9 hours under a nitrogen atmosphere while being stirred. Then, the contents of the reaction vessel were reacted at 220° C. under reduced pressure (pressure of 8 kPa) while being stirred until the softening point of the resin serving as the reaction product reached a value shown in Table 1. Consequently, an amorphous polyester resin (RA-A) was obtained. The amorphous polyester resin (RA-A) was determined to be amorphous because no clear endothermic peak was observed in an endothermic curve measured using a differential scanning calorimeter. The softening point, the glass transition point, the acid value, the hydroxyl value, the mass average molecular weight and the number average molecular weight of the amorphous polyester resin (RA-A) were as shown in the “RA-A” column of Table 1.

### <Preparation of Amorphous Polyester Resin (RA-D)>

An amorphous polyester resin (RA-D) was prepared by the same method as the method for preparing the amorphous polyester resin (RA-A) except that the types and amounts of monomers placed into the reaction vessel were set to those shown in the “RA-D” column of Table 1. The amorphous polyester resin (RA-D) was determined to be amorphous because no clear endothermic peak was observed in an endothermic curve measured using the differential scanning calorimeter. The softening point, the glass transition point, the acid value, the hydroxyl value, the mass average molecular weight and the number average molecular weight of the amorphous polyester resin (RA-D) were as shown in the “RA-D” column of Table 1.

### [Composite Resin]

Composite resins used to form the toner cores were prepared by the following method. Each of the composite resins is a composite resin of a crystalline polyester resin and a styrene-acrylic resin. The details of the composite resins are shown in Table 2 below.

Table 2 is as follows.

TABLE 2

| Composite resin | | | | RC-a | RC-d |
|---|---|---|---|---|---|
| Monomer | Crystalline | Polyhydric | 1,4-BD | 995 | — |
| amount | polyester | alcohol monomer | 1,6-HD | 260 | — |
| [g] | resin | | EG | — | 870 |
| | | Polycarboxylic | FA | 1500 | — |
| | | acid monomer | SA | — | 1480 |
| | | Styrene-based | ST | 70 | 70 |
| | | monomer | | | |
| | Styrene- | Acrylic acid- | BM | 50 | 50 |
| | acrylic resin | based monomer | | | |

| | | |
|---|---|---|
| Tm [° C.] | 88.8 | 76.0 |
| Mp [° C.] | 82 | 75 |
| Acid value [mgKOH/g] | 3.1 | 18.0 |
| Hydroxyl value [mgKOH/g] | 19.0 | 10.0 |
| Mw | 27500 | 25000 |
| Mn | 3620 | 2400 |

Terms used in Table 2 are as follows:
Tm: softening point
Mp: melting point
Mw: mass average molecular weight
Mn: number average molecular weight
1,4-BD: 1,4-butanediol
1,6-HD: 1,6-hexanediol
EG: ethylene glycol
FA: fumaric acid
SA: sebacic acid
ST: styrene
BM: butyl methacrylate
-: corresponding monomer is not used

### <Preparation of Composite Resin (RC-a)>

A four-neck flask including a nitrogen inlet tube, a dehydration tube, a stirrer and a thermocouple was used as a reaction vessel. Polyhydric alcohol monomers and a polycarboxylic acid monomer shown in the “RC-a” column of Table 2 were placed into the reaction vessel in amounts shown in this column. 2.5 g of hydroquinone was added to the reaction vessel. The contents of the reaction vessel were reacted at 170° C. for 5 hours under a nitrogen atmosphere while being stirred. Then, the contents of the reaction vessel were reacted at 210° C. for 1.5 hours under a nitrogen atmosphere while being stirred. Then, the contents of the reaction vessel were reacted at 210° C. for 1 hour under reduced pressure (pressure of 8 kPa) while being stirred. The pressure inside the reaction vessel was returned to normal pressure, and a styrene-based monomer and an acrylic acid-based monomer shown in the “RC-a” column of Table 2 were placed into the reaction vessel in amounts shown in this column. The contents of the reaction vessel were reacted at 210° C. for 1.5 hours while being stirred. Then, the contents of the reaction vessel were reacted at 210° C. for 1 hour under reduced pressure (pressure of 8 kPa) while being stirred. Consequently, the composite resin “RC-a” of the crystalline polyester resin and the styrene-acrylic resin was obtained. The softening point, the melting point, the acid value, the hydroxyl value, the mass average molecular weight and the number average molecular weight of the composite resin “RC-a” were as shown in the “RC-a” column of Table 2. The crystallinity index (that is, Tm/Mp) of the composite resin “RC-a” was 1.08.

### <Preparation of Composite Resin (RC-d)>

A composite resin (RC-d) was prepared by the same method as the method for preparing the composite resin (RC-a) except that the type and amount of polyhydric alcohol monomer, the type and amount of polycarboxylic acid monomer, the type and amount of styrene-based monomer and the type and amount of acrylic acid-based monomer placed into the reaction vessel were set to those shown in the “RC-d” column of Table 2. The composite resin (RC-d) was a composite resin of the crystalline polyester resin and the styrene-acrylic resin. The softening point, the melting point, the acid value, the hydroxyl value, the mass average molecular weight and the number average molecular weight of the composite resin “RC-d” were as shown in the “RC-d” column of Table 2. The crystallinity index (that is, Tm/Mp) of the composite resin “RC-d” was 1.01.

### [Mold Release Agent]

The following commercially available mold release agent was used to form the toner cores.
Mold release agent (W-1): ester wax (“Nissan Electol (registered trademark) WEP-3” made by NOF Corporation)

### [Colorant]

The following commercially available colorants were used to form the toner cores.
Colorant (C-1): black colorant (“MA-100” made by Mitsubishi Chemical Corporation, carbon black, number average primary particle diameter: 24 nm, DBP absorption amount: 100 cm³/100 g)
Colorant (C-2): cyan colorant (“KET BLUE 111” made by DIC Corporation)
Colorant (C-3): magenta colorant (“PERMANENT CARMINE 6902” made by Sanyo Color Works, LTD.)
Colorant (C-4): yellow colorant (“Hansa Brilliant Yellow 5GX-01” made by Clariant)
Colorant (C-5): black colorant (“REGAL (registered trademark) 330” made by Cabot Corporation, carbon black)
Colorant (C-6): cyan colorant (“FASTOGEN (registered trademark) BLUE PA5380” made by DIC Corporation, C. I. Pigment Blue 15:3)
Colorant (C-7): magenta colorant (“CHROMOFINE MAGENTA 6870” made by Dainichiseika Color & Chemicals Mfg. Co., Ltd.)
Colorant (C-8): yellow colorant (“SEIKAFAST YELLOW 2054K” made by Dainichiseika Color & Chemicals Mfg. Co., Ltd.)
Colorant (C-9): black colorant (“#44” made by Mitsubishi Chemical Corporation, carbon black, number average primary particle diameter: 24 nm, DBP absorption amount: 78 cm³/100 g)
Colorant (C-10): cyan colorant (“KET BLUE 105” made by DIC Corporation)

### [Shell Particle Suspension]

First shell particle suspensions (S-B) and (S-E) and second shell particle suspensions (S-C) and (S-F) used to form shell layers were prepared by the following method.

### <Preparation of First Shell Particle Suspension (S-B)>

A four-neck flask including a thermometer, a stirring blade, a reflux condenser and a monomer dropping port was used as a first reaction vessel. The first reaction vessel was set in a water bath. 360 parts by mass of ion-exchanged water for emulsification and 2.0 parts by mass of a reactive emulsifier (“ADEKA REASOAP (registered trademark) SR-1025” made by ADEKA Corporation) were placed into the first reaction vessel. Then, the temperature inside the first reaction vessel was raised to 80° C. using the water bath. Then, 30 parts by mass of styrene, 50 parts by mass of n-butyl acrylate, 20 parts by mass of 2-hydroxyethyl methacrylate, 3.2 parts by mass of the reactive emulsifier (“ADEKA REASOAP (registered trademark) SR-1025” made by ADEKA Corporation) and 40 parts by mass of ion-exchanged water for emulsification were placed into the first reaction vessel. The contents of the first reaction vessel were stirred at a stirring speed of 10000 rpm for 5 minutes using a high-speed shear emulsifier (“Clearmix (registered trademark) CLM-2.2S” made by M Technique Co., Ltd.), and thus the contents of the first reaction vessel were emulsified. Consequently, a monomer suspension MB was obtained.

Another four-neck flask including a thermometer, a stirring blade, a reflux condenser and a monomer dropping port was used as a second reaction vessel. 0.2 parts by mass of ammonium persulfate was placed into the second reaction vessel. Then, 28.6 parts by mass of the monomer suspension MB was added to the second reaction vessel, and emulsion polymerization was performed for 30 minutes. Thereafter, 114.5 parts by mass of the monomer suspension MB was dropped into the second reaction vessel over a period of 3 hours. After the completion of the dropping, the contents of the second reaction vessel were subjected to emulsion polymerization for an additional hour. Then, 5.9 parts by mass of ion-exchanged water for dilution was added to the second reaction vessel. The temperature inside the second reaction vessel was cooled to 40° C. Consequently, the first shell particle suspension (S-B) was obtained. A first shell particle contained in the first shell particle suspension (S-B) was formed of a polymer of styrene, n-butyl acrylate and 2-hydroxyethyl methacrylate.

### <Preparation of First Shell Particle Suspension (S-E)>

The first shell particle suspension (S-E) was prepared by the same method as the method for preparing the first shell particle suspension (S-B) except that instead of 30 parts by mass of styrene, 50 parts by mass of n-butyl acrylate and 20 parts by mass of 2-hydroxyethyl methacrylate, 20 parts by mass of 2-(ethoxymethyl)styrene, 50 parts by mass of n-butyl acrylate and 30 parts by mass of acrylonitrile were used. A first shell particle contained in the first shell particle suspension (S-E) was formed of a polymer of 2-(ethoxymethyl)styrene, n-butyl acrylate and acrylonitrile.

### <Preparation of Second Shell Particle Suspension (S-C)>

A four-neck flask including a thermometer, a stirring blade, a reflux condenser and a monomer dropping port was used as a first reaction vessel. The first reaction vessel was set in a water bath. 200 parts by mass of ion-exchanged water for emulsification and 1.5 parts by mass of an anionic surfactant (“EMAL (registered trademark) 0” made by Kao Corporation) were placed into the first reaction vessel. Then, the temperature inside the first reaction vessel was raised to 80° C. using the water bath. Then, 45 parts by mass of methyl methacrylate, 50 parts by mass of styrene, 5 parts by mass of divinylbenzene serving as a cross-linking agent, 3 parts by mass of the anionic surfactant (“EMAL (registered trademark) 0” made by Kao Corporation) and 40 parts by mass of ion-exchanged water for emulsification were placed into the first reaction vessel. The contents of the first reaction vessel were stirred at a stirring speed of 10000 rpm for 5 minutes using the high-speed shear emulsifier (“Clearmix (registered trademark) CLM-2.2S” made by M Technique Co., Ltd.), and thus the contents of the first reaction vessel were emulsified. Consequently, a monomer suspension MC was obtained.

Another four-neck flask including a thermometer, a stirring blade, a reflux condenser and a monomer dropping port was used as a second reaction vessel. 1.0 part by mass of ammonium persulfate was placed into the second reaction vessel. Then, 100 parts by mass of the monomer suspension MC was dropped into the second reaction vessel over a period of 3 hours, and emulsion polymerization was performed. After the completion of the dropping, the contents of the second reaction vessel were subjected to emulsion polymerization for an additional hour. Consequently, the second shell particle suspension (S-C) was obtained. A second shell particle contained in the second shell particle suspension (S-C) was formed of a polymer of methyl methacrylate, styrene and divinylbenzene.

### <Preparation of Second Shell Particle Suspension (S-F)>

The second shell particle suspension (S-F) was prepared by the same method as the method for preparing the second shell particle suspension (S-C) except that instead of 45 parts by mass of methyl methacrylate, 50 parts by mass of styrene, 5 parts by mass of divinylbenzene and 3 parts by mass of the anionic surfactant, 45 parts by mass of methyl methacrylate, 20 parts by mass of 2-(ethoxymethyl)styrene, 2 parts by mass of 2-hydroxyethyl methacrylate and 2 parts by mass of 2-(methacryloyloxy)ethyltrimethylammonium chloride were used. A second shell particle contained in the second shell particle suspension (S-F) was formed of a polymer of methyl methacrylate, 2-(ethoxymethyl)styrene, 2-hydroxyethyl methacrylate and 2-(methacryloyloxy)ethyltrimethylammonium chloride.

[Toner]

Toners used in Examples and Comparative Examples were prepared by the following method. The details of the toner cores of the toners are shown in Tables 3 and 4 below. The details of the shell layers of the toners are shown in Tables 5 and 6 below.

Table 3 is as follows.

TABLE 3

| | Toner core | | | | | | | | |
|---|---|---|---|---|---|---|---|---|---|
| | | | | | | | Colorant | | |
| | Amorphous | | Composite | | Mold release | | | Amount | |
| | resin | | resin | | agent | | | [parts/ | Turbidity |
| | | Ratio | | Ratio | | Ratio | | amorphous | meter |
| Toner | Type | [%] | Type | [%] | Type | [%] | Type | 100 parts] | concentration |
| T-A1 | RA-A | 73.8 | RC-a | 10.0 | W-1 | 5.0 | C-1 | 15.1 | 5553 |
| T-A2 | RA-A | 72.6 | RC-a | 10.0 | W-1 | 5.0 | C-1 | 17.1 | 5980 |
| T-A3 | RA-A | 76.2 | RC-a | 10.0 | W-1 | 5.0 | C-1 | 11.5 | 5052 |
| T-A4 | RA-A | 75.8 | RC-a | 10.0 | W-1 | 5.0 | C-2 | 12.2 | 1614 |
| T-A5 | RA-A | 72.3 | RC-a | 10.0 | W-1 | 5.0 | C-2 | 17.1 | 1692 |
| T-A6 | RA-A | 76.3 | RC-a | 10.0 | W-1 | 5.0 | C-2 | 11.5 | 1521 |
| T-A7 | RA-A | 73.0 | RC-a | 10.0 | W-1 | 5.0 | C-3 | 16.5 | 1307 |
| T-A8 | RA-A | 72.6 | RC-a | 10.0 | W-1 | 5.0 | C-3 | 17.0 | 1443 |
| T-A9 | RA-A | 73.3 | RC-a | 10.0 | W-1 | 5.0 | C-3 | 16.0 | 1250 |
| T-A10 | RA-A | 73.8 | RC-a | 10.0 | W-1 | 5.0 | C-4 | 15.1 | 920 |
| T-A11 | RA-A | 72.6 | RC-a | 10.0 | W-1 | 5.0 | C-4 | 17.1 | 945 |
| T-A12 | RA-A | 76.2 | RC-a | 10.0 | W-1 | 5.0 | C-4 | 11.5 | 856 |
| T-A13 | RA-A | 74.0 | RC-a | 10.0 | W-1 | 5.0 | C-5 | 14.9 | 5532 |
| T-A14 | RA-A | 74.0 | RC-a | 10.0 | W-1 | 5.0 | C-5 | 14.9 | 5523 |
| T-A15 | RA-A | 76.0 | RC-a | 10.0 | W-1 | 5.0 | C-6 | 11.9 | 1612 |
| T-A16 | RA-A | 76.0 | RC-a | 10.0 | W-1 | 5.0 | C-6 | 11.9 | 1613 |
| T-A17 | RA-A | 72.9 | RC-a | 10.0 | W-1 | 5.0 | C-7 | 16.6 | 1308 |
| T-A18 | RA-A | 72.9 | RC-a | 10.0 | W-1 | 5.0 | C-7 | 16.6 | 1303 |
| T-A19 | RA-A | 74.0 | RC-a | 10.0 | W-1 | 5.0 | C-8 | 14.9 | 901 |
| T-A20 | RA-A | 74.0 | RC-a | 10.0 | W-1 | 5.0 | C-8 | 14.9 | 899 |
| T-A21 | RA-D | 76.0 | RC-d | 10.0 | W-1 | 5.0 | C-6 | 11.9 | 1615 |
| T-A22 | RA-A | 76.0 | RC-a | 10.0 | W-1 | 5.0 | C-6 | 11.9 | 1611 |

Table 4 is as follows.

TABLE 4

| | Toner core | | | | | | | | |
|---|---|---|---|---|---|---|---|---|---|
| | | | | | | | Colorant | | |
| | Amorphous | | Composite | | Mold release | | | Amount | |
| | resin | | resin | | agent | | | [parts/ | Turbidity |
| | | Ratio | | Ratio | | Ratio | | amorphous | meter |
| Toner | Type | [%] | Type | [%] | Type | [%] | Type | 100 parts] | concentration |
| T-B1 | RA-A | 72.5 | RC-a | 10.0 | W-1 | 5.0 | C-9 | 17.2 | 6060 |
| T-B2 | RA-A | 76.3 | RC-a | 10.0 | W-1 | 5.0 | C-9 | 11.4 | 4879 |
| T-B3 | RA-A | 72.5 | RC-a | 10.0 | W-1 | 5.0 | C-10 | 17.2 | 1724 |
| T-B4 | RA-A | 76.3 | RC-a | 10.0 | W-1 | 5.0 | C-10 | 11.4 | 1488 |
| T-B5 | RA-A | 72.5 | RC-a | 10.0 | W-1 | 5.0 | C-7 | 17.2 | 1502 |
| T-B6 | RA-A | 76.3 | RC-a | 10.0 | W-1 | 5.0 | C-7 | 11.4 | 1238 |
| T-B7 | RA-A | 72.5 | RC-a | 10.0 | W-1 | 5.0 | C-8 | 17.2 | 968 |
| T-B8 | RA-A | 76.3 | RC-a | 10.0 | W-1 | 5.0 | C-8 | 11.4 | 846 |
| T-B9 | RA-A | 74.0 | RC-a | 10.0 | W-1 | 5.0 | C-9 | 14.9 | 5540 |
| T-B10 | RA-A | 74.0 | RC-a | 10.0 | W-1 | 5.0 | C-9 | 14.9 | 5531 |
| T-B11 | RA-A | 76.0 | RC-a | 10.0 | W-1 | 5.0 | C-10 | 11.9 | 1607 |
| T-B12 | RA-A | 76.0 | RC-a | 10.0 | W-1 | 5.0 | C-10 | 11.9 | 1611 |
| T-B13 | RA-A | 72.9 | RC-a | 10.0 | W-1 | 5.0 | C-7 | 16.6 | 1309 |
| T-B14 | RA-A | 72.9 | RC-a | 10.0 | W-1 | 5.0 | C-7 | 16.6 | 1305 |
| T-B15 | RA-A | 74.0 | RC-a | 10.0 | W-1 | 5.0 | C-8 | 14.9 | 903 |
| T-B16 | RA-A | 74.0 | RC-a | 10.0 | W-1 | 5.0 | C-8 | 14.9 | 896 |

Terms used in Tables 3 and 4 are as follows:
Amorphous resin: amorphous polyester resin
%: % by mass
Part: part by mass
Ratio [%]: Content of corresponding component in toner core (unit: 0% by mass)
Amount [parts/amorphous 100 parts]: Content of colorant with respect to 100.0 parts by mass of amorphous polyester resin (unit: parts by mass)

Table 5 is as follows.

TABLE 5

| | Shell layer | | | | |
|---|---|---|---|---|---|
| | First shell particle | | Second shell particle | | Shell layer |
| | suspension | | suspension | | coverage |
| Toner | Type | Amount [mL] | Type | Amount [mL] | ratio [%] |
| T-A1 | S-B | 150 | S-C | 10 | 54.1 |
| T-A2 | S-B | 150 | S-C | 10 | 52.2 |
| T-A3 | S-B | 150 | S-C | 10 | 56.6 |
| T-A4 | S-B | 150 | S-C | 10 | 51.3 |
| T-A5 | S-B | 150 | S-C | 10 | 49.9 |
| T-A6 | S-B | 150 | S-C | 10 | 53.2 |
| T-A7 | S-B | 150 | S-C | 10 | 55.5 |
| T-A8 | S-B | 150 | S-C | 10 | 52.1 |
| T-A9 | S-B | 150 | S-C | 10 | 49.6 |
| T-A10 | S-B | 150 | S-C | 10 | 50.2 |
| T-A11 | S-B | 150 | S-C | 10 | 49.5 |
| T-A12 | S-B | 150 | S-C | 10 | 47.6 |
| T-A13 | S-B | 220 | S-C | 12 | 59.5 |
| T-A14 | S-B | 80 | S-C | 6 | 32.4 |
| T-A15 | S-B | 220 | S-C | 12 | 59.9 |
| T-A16 | S-B | 80 | S-C | 6 | 32.4 |
| T-A17 | S-B | 220 | S-C | 12 | 58.9 |
| T-A18 | S-B | 80 | S-C | 6 | 33.5 |
| T-A19 | S-B | 220 | S-C | 12 | 59.2 |
| T-A20 | S-B | 80 | S-C | 6 | 30.3 |
| T-A21 | S-B | 150 | S-C | 10 | 49.7 |
| T-A22 | S-E | 150 | S-F | 10 | 51.2 |

Table 6 is as follows.

TABLE 6

| | Shell layer | | | | |
|---|---|---|---|---|---|
| | First shell particle | | Second shell particle | | Shell layer |
| | suspension | | suspension | | coverage |
| Toner | Type | Amount [mL] | Type | Amount [mL] | ratio [%] |
| T-B1 | S-B | 150 | S-C | 10 | 53.8 |
| T-B2 | S-B | 150 | S-C | 10 | 51.3 |
| T-B3 | S-B | 150 | S-C | 10 | 57.4 |
| T-B4 | S-B | 150 | S-C | 10 | 50.8 |
| T-B5 | S-B | 150 | S-C | 10 | 50.2 |
| T-B6 | S-B | 150 | S-C | 10 | 52.9 |
| T-B7 | S-B | 150 | S-C | 10 | 51.5 |
| T-B8 | S-B | 150 | S-C | 10 | 54.6 |
| T-B9 | S-B | 260 | S-C | 18 | 61.2 |
| T-B10 | S-B | 50 | S-C | 5 | 28.8 |
| T-B11 | S-B | 260 | S-C | 18 | 62.4 |
| T-B12 | S-B | 50 | S-C | 5 | 28.7 |
| T-B13 | S-B | 260 | S-C | 18 | 61.8 |
| T-B14 | S-B | 50 | S-C | 5 | 29.3 |
| T-B15 | S-B | 260 | S-C | 18 | 60.9 |
| T-B16 | S-B | 50 | S-C | 5 | 28.3 |

<Preparation of toner (T-A1)>

### (Formation of Toner Core)

The amorphous polyester resin (RA-A), the composite resin (RC-a) of the crystalline polyester resin and the styrene-acrylic resin, the mold release agent (W-1) and the colorant (C-1) were placed into an FM mixer (“FM-20B” made by NIPPON COKE & ENGINEERING COMPANY, LIMITED) in such amounts that contents shown in Table 3 were achieved. The content of the colorant (C-1) was determined from a formula “100.0−(content of amorphous polyester resin+content of composite resin+content of mold release agent)”, and the colorant (C-1) was placed thereinto in such an amount that the determined content was achieved. The FM mixer was used to mix the contents of the FM mixer, and thus a mixture was obtained. Using a twin-screw extruder (“PCM-30” made by Ikegai Corporation), the mixture was kneaded while being melted under conditions of a material supply rate of 6 kg/hour, an axis rotation speed of 160 rpm and a cylinder temperature of 120° C., with the result that a kneaded product was obtained. The kneaded product was cooled. The cooled kneaded product was coarsely pulverized using a pulverizer (“Rotoplex (registered trademark) 16/8 type” made by Toa Machinery Works, Ltd.), and thus a coarsely pulverized product was obtained. The coarsely pulverized product was finely pulverized using a pulverizer (“Turbo Mill RS” made by FREUND-Turbo Corporation), and thus a finely pulverized product was obtained. The finely pulverized product was classified using an elbow jet (“EJ-LABO” made by Nittetsu Mining Co., Ltd., model EJ-L-3), and thus the toner core having a volume median diameter of 7 m was obtained.

### (Formation of Shell Layer)

100 mL of ion-exchanged water was placed into a three-neck flask including a thermometer and a stirring blade. The temperature of the contents of the flask was held at 30° C. using a water bath. Dilute hydrochloric acid was added into the flask to adjust the pH of the contents of the flask (which corresponds to the shelling pH) to 4. 150 mL of the first shell particle suspension (S-B) and 10 mL of the second shell particle suspension (S-C) were added into the flask as shell materials. 300 g of the toner base particle was further added into the flask, and the contents of the flask were stirred at a speed of 200 rpm for 1 hour. Then, 300 mL of ion-exchanged water was added into the flask. While the contents of the flask were stirred at a rate of 100 rpm, the temperature of the contents of the flask was increased to 70° C. at a rate of 1° C./min. After the temperature was increased, the temperature of the contents of the flask was kept at 70° C. for 2 hours while the contents of the flask was being stirred at a speed of 100 rpm. The temperature of the contents of the flask was kept at 70° C., and thus the shell layer was formed on the surface of the toner core. Consequently, a dispersion liquid of the toner base particle was obtained.

Then, sodium hydroxide was used to adjust the pH of the dispersion liquid of the toner base particle to 7. Then, the dispersion liquid of the toner base particle was cooled to 25° C. Then, the dispersion liquid of the toner base particle was filtered (filtration treatment) using a Buchner funnel, and thus the toner base particle in the shape of a wet cake was obtained. The toner base particle in the shape of a wet cake was redispersed in ion-exchanged water (dispersion treatment). The filtration treatment and the dispersion treatment were repeated five times, and thus the toner base particle was washed. The washed toner base particle was dispersed in an aqueous ethanol solution having a concentration of 50% by mass. In this way, a slurry of the toner base particle was obtained. Then, the slurry of the toner base particle was dried using a continuous surface modification device (“Coatmizer (registered trademark)” made by FREUND Corporation) under conditions of a hot air temperature of 45° C. and a blower air volume of 2 m³/min. In this way, the dried toner base particle was obtained.

### (External Addition)

100.0 parts by mass of the toner base particle, 1.2 parts by mass of hydrophobic silica particle (“RA-200H” made by Nippon Aerosil Co., Ltd.) and 0.8 parts by mass of titanium oxide particle (“EC-100” made by Titanium Kogyo, Ltd.) were mixed for 2 minutes using an FM mixer (“FM-10B” made by NIPPON COKE & ENGINEERING COMPANY, LIMITED) at a rotation speed of 3000 rpm and a jacket control temperature of 20° C. By the mixing, the external additives (the hydrophobic silica particle and the titanium oxide particle) were adhered to the surface of the toner base particle, and thus a toner particle was obtained. In this way, a toner (T-A1) including the toner particle was obtained.

### <Preparation of Toners (T-A2) to (T-A22) and Toners (T-B1) to (T-B16)>

Toners (T-A2) to (T-A22) and toners (T-B1) to (T-B16) were prepared by the same method as the method for preparing the toner (T-A1) except that in the formation of the toner core, the types and contents of the amorphous polyester resin, the types and contents of the composite resin, the types and contents of the mold release agent and the types of the colorants were set to those shown in Tables 3 and 4, in the formation of the toner core, the content of the colorant was set to the content calculated from a formula “100.0−(content of amorphous polyester resin+content of composite resin+content of mold release agent)” and in the formation of the shell layer, the types and amounts of the first shell particle suspension and the types and amounts of the second shell particle suspension were set to those shown in Tables 5 and 6.

Although in the preparation of each of the toners, the target was to adjust the shelling pH to 4, a slight error (an error of about pH 4±0.5) occurred in the shelling pH of the toner. As the shelling pH was increased beyond 4, the shell materials are less likely to adhere to the toner core, and thus the shell layer coverage ratio tended to be lowered. By contrast, as the shelling pH was lowered beyond 4, the shell materials easily adhered to the toner core, and thus the shell layer coverage ratio tended to be increased. Hence, even though the types and amounts of the first shell particle suspension and the types and amounts of the second shell particle suspension were the same, the toners which had different shell layer coverage ratios due to the slight error in the shelling pH were obtained.

### [Measurements]

The contents of the colorants with respect to 100.0 parts by mass of the amorphous polyester resin and the shell layer coverage ratios were measured for the toners by the following method. The contents of the colorants which were measured are shown in Tables 3 and 4. The shell layer coverage ratios which were measured are shown in Tables 5 and 6.

### <Content of Colorant>

The mass WC of the colorant contained in 10 mg of the toner core and the mass WRA of the amorphous polyester resin contained in 10 mg of the toner core were measured by the following method. Then, the content of the colorant with respect to 100.0 parts by mass of the amorphous polyester resin was determined from a formula “content of colorant=100.0×WC/WRA”.

### (Measurement of Mass WC of Colorant)

10 mg of the toner core (that is, the toner core before the formation of the shell layer) was placed into 40 mL of THF, and was subjected to ultrasonic treatment for 2 minutes using an ultrasonic vibrator, and thus a first sample was obtained. In the first sample, the amorphous polyester resin was dissolved in THF, and the crystalline polyester resin, the mold release agent and the colorant were dispersed without being dissolved in THF. The colorant concentration (that is, the turbidity) of the first sample was measured using a turbidity meter (“NDR2000” which is a wastewater color meter/color contamination meter made by Nippon Denshoku Industries Co., Ltd.). Using a calibration curve, the measured colorant concentration was converted into the mass of the colorant. The converted value was assumed to be the mass WC of the colorant contained in 10 mg of the toner core. The calibration curve described above was prepared by using the toner core in which the mass of the colorant had been previously known.

### (Measurement of Mass WRA of Amorphous Polyester Resin)

10 mg of the toner core (that is, the toner core before the formation of the shell layer) was placed into 40 mL of THF, and was subjected to ultrasonic treatment for 2 minutes at room temperature (25° C.) using an ultrasonic vibrator, and thus a second sample was obtained. In the second sample, the amorphous polyester resin was dissolved in THF, and the crystalline polyester resin, the mold release agent and the colorant were dispersed without being dissolved in THF. The second sample was filtered, and thus a filtrate from which THF-insoluble components (specifically, the crystalline polyester resin and the mold release agent) had been removed was obtained. Since the amorphous polyester resin was dissolved in the filtrate, the filtrate was dried, and the mass of the amorphous polyester resin was measured. The mass of the amorphous polyester resin which was measured was assumed to be the mass WRA of the amorphous polyester resin contained in 10 mg of the toner core.

### <Shell Layer Coverage Ratio>

The toner base particle was placed on a ruthenium tetroxide solution, and was exposed to a ruthenium vapor atmosphere. The toner base particle was dyed with ruthenium by the exposure. The toner base particle dyed with ruthenium was observed at a magnification of 50000 times using a scanning electron microscope (SEM, “JSM-7600F” made by JEOL Ltd.), and a reflected electron image of the toner base particle was obtained. The pixels of the reflected electron image each showed a brightness value equal to or greater than 0 and equal to or less than 255. Using image analysis software (“WinROOF” made by Mitani Shoji Co., Ltd.), the reflected electron image was binarized with a brightness value of 144 used as a reference. A region covered by the shell layer in the surface region of the toner core is easily dyed with ruthenium, and tends to show a brightness value of 144 or more. By the binarization processing, the area (A) of the entire reflected electron image of the toner base particle and the area (A144) of the region in the reflected electron image where the brightness value was equal to or greater than 144 were calculated. A shell layer coverage ratio (unit: %) was calculated from a formula “shell layer coverage ratio=100×(A144)/(A)”. Whether the shell layer coverage ratio was equal to or greater than 30% and equal to or less than 60% was determined by rounding the first decimal place of the measured shell layer coverage rate.

### [Evaluation]

The minimum fixing temperature, the maximum fixing temperature, color development and heat-resistant storage stability of the toners were evaluated by the following methods. Evaluation values and determinations in evaluations are shown in Tables 7 and 8.

### <Two-Component Developer for Evaluation>

A two-component developer used for evaluations of the minimum fixing temperature, the maximum fixing temperature and the color development was prepared by the following method. The two-component developer for evaluation was prepared by mixing, using a ball mill, 100 parts by mass of a carrier (standard carrier “P-01” provided by the Imaging Society of Japan) and 7 parts by mass of a toner (any one of the toners (T-A1) to (T-A22) and the toners (T-B1) to (T-B16)).

### <Evaluation Machine>

As an evaluation machine used to evaluate the minimum fixing temperature, the maximum fixing temperature and the color development, a multifunctional peripheral (“TASKalfa 7054ci” made by Kyocera Document Solutions Inc.) was used which was modified to be able to adjust a fixing temperature. The linear speed of the evaluation machine was set to 322 mm/second. The two-component developer for evaluation was put into the development unit of the evaluation machine, and the toner was put into the toner container of the evaluation machine.

### <Minimum Fixing Temperature>

A toner amount in the evaluation machine was set to 0.37 mg/cm². Using the evaluation machine, an unfixed solid image was formed on a recording medium (monochrome/color copy paper, “C2” made by Fujifilm Business Innovation Co., Ltd.). The fixing temperature of the evaluation machine was increased in increments of 5° C. from 120° C. within a range equal to or greater than 120° C. and equal to or less than 220° C., and the unfixed solid image was fixed at each fixing temperature. The recording medium on which the solid image was fixed was folded in half such that the surface where the image was formed was directed inward. A weight of 1 kg covered with fabric was used to rub the fold of the recording medium back and forth five times. Then, the folded recording medium was unfolded, and whether the toner was peeled off 1 mm or more on the fold was checked. A case where the toner was not peeled off 1 mm or more was determined to be acceptable whereas a case where the toner was peeled off 1 mm or more was determined to be unacceptable. The lowest fixing temperature among the fixing temperatures at which the toner was not peeled off 1 mm or more was assumed to be the minimum fixing temperature (evaluation value). The minimum fixing temperature was determined according to the following criteria. As the minimum fixing temperature was lower, the low-temperature fixability was determined to be more excellent.

### (Criteria for Minimum Fixing Temperature)

A (satisfactory): minimum fixing temperature is equal to or less than 150° C.
B (unsatisfactory): minimum fixing temperature is equal to or greater than 155° C. and equal to or less than 160° C.
C (particularly unsatisfactory): minimum fixing temperature is equal to or greater than 165° C.

### <Maximum Fixing Temperature>

A toner amount in the evaluation machine was set to 0.25 mg/cm². Using the evaluation machine, an unfixed solid image was formed on the recording medium (monochrome/color copy paper, “C2” made by Fujifilm Business Innovation Co., Ltd.). The fixing temperature of the evaluation machine was increased in increments of 5° C. from 120° C. within a range equal to or greater than 120° C. and equal to or less than 220° C., and the unfixed solid image was fixed at each fixing temperature. Whether there was a stain caused by a hot offset on the recording medium on which the solid image was fixed was checked. A stain caused by a hot offset refers to a stain caused by the adherence of the toner to a fixing roller (for example, a stain which appeared per rotation cycle of the fixing roller). When there was a stain caused by a hot offset, using a fluorescent spectrodensitometer (“FD-5” made by Konica Minolta, Inc.), the image density A of the stained part on the recording medium caused by the hot offset was measured. Using the fluorescent spectrodensitometer (“FD-5” made by Konica Minolta, Inc.), the image density B of the unprinted recording medium was measured. A stain density was determined from a formula “stain density=image density A−image density B”. When the stain density was less than 0.005, the stain density was determined to be acceptable whereas when the stain density was equal to or greater than 0.005, the stain density was determined to be unacceptable. Among fixing temperatures at which there was no stain caused by a hot offset or there was a stain caused by a hot offset but the stain density was determined to be acceptable, the maximum temperature was assumed to be the maximum fixing temperature (evaluation value). The maximum fixing temperature was determined according to the following criteria. As the maximum fixing temperature was higher, the hot offset resistance was determined to be more excellent.

### (Criteria for Maximum Fixing Temperature)

A (satisfactory): maximum fixing temperature is equal to or greater than 205° C.
B (unsatisfactory): maximum fixing temperature is equal to or greater than 190° C. and equal to or less than 200° C.
C (particularly unsatisfactory): maximum fixing temperature is equal to or greater than 185° C.

### <Color Development>

A toner amount in the evaluation machine was set to 0.37 mg/cm². Using the evaluation machine, an unfixed solid image was formed on the recording medium (monochrome/color copy paper, “C2” made by Fujifilm Business Innovation Co., Ltd.). The unfixed solid image was fixed at a fixing temperature of 170° C. Using the fluorescent spectrodensitometer (“FD-5” made by Konica Minolta, Inc.), the image density (evaluation value) of the fixed solid image was measured. Color development was determined according to the following criteria.

### (Criteria for Color Development of Black Colorant)

A1 (satisfactory): image density is equal to or greater than 1.60
B1 (unsatisfactory): image density is less than 1.60
   (Criteria for Color Development of Colorants Other than Black Colorant)
A2 (satisfactory): image density is equal to or greater than 1.45
B2 (unsatisfactory): image density is less than 1.45

### <Heat-Resistant Storage Stability>

3 g of the toner was placed into a 20 mL plastic container, and was allowed to stand in a temperature-controlled chamber set at 55° C. for 3 hours. The toner after the standing was used as a toner for evaluating heat-resistant storage stability. The toner for evaluating heat-resistant storage stability was sieved using a 200 mesh sieve (with an opening of 75 m), under the conditions of a rheostat scale of 5 and a time period of 30 seconds, according to the manual of Powder Tester (registered trademark) (made by Hosokawa Micron Corporation). After the sieving, the mass TA of the toner left on the sieve was measured. An aggregation degree (evaluation value, unit: %) was determined from the mass TB of the toner before the sieving and the mass TA of the toner left on the sieve after the sieving according to a formula “aggregation degree=100×TA/TB”. Heat-resistant storage stability was determined according to the following criteria.

### (Criteria for Heat-Resistant Storage Stability)

A (satisfactory): aggregation degree is equal to or less than 10%
B (unsatisfactory): aggregation degree is greater than 10% and equal to or less than 20%
C (particularly unsatisfactory): aggregation degree is greater than 20%

Table 7 is as follows. “EX1” indicates Example 1. “EX2” indicates Example 2. “EX3” indicates Example 3. “EX4” indicates Example 4. “EX5” indicates Example 5. “EX6” indicates Example 6. “EX7” indicates Example 7. “EX8” indicates Example 8. “EX9” indicates Example 9. “EX10” indicates Example 10. “EX11” indicates Example 11. “EX12” indicates Example 12. “EX13” indicates Example 13. “EX14” indicates Example 14. “EX15” indicates Example 15. “EX16” indicates Example 16. “EX17” indicates Example 17. “EX18” indicates Example 18. “EX19” indicates Example 19. “EX20” indicates Example 20. “EX21” indicates Example 21. “EX22” indicates Example 22.

TABLE 7

| | | Minimum fixing | | Maximum fixing | | Color | | Heat-resistant | |
|---|---|---|---|---|---|---|---|---|---|
| | | temperature | | temperature | | development | | storage stability | |
| | | Value | Determi- | Value | Determi- | | Determi- | Value | Determi- |
| | Toner | [° C.] | nation | [° C.] | nation | Value | nation | [%] | nation |
| EX1 | T-A1 | 140 | A | 210 | A | 1.65 | A1 | 5 | A |
| EX2 | T-A2 | 145 | A | 215 | A | 1.75 | A1 | 3 | A |
| EX3 | T-A3 | 135 | A | 205 | A | 1.60 | A1 | 6 | A |
| EX4 | T-A4 | 135 | A | 205 | A | 1.47 | A2 | 4 | A |
| EX5 | T-A5 | 140 | A | 210 | A | 1.61 | A2 | 3 | A |
| EX6 | T-A6 | 130 | A | 205 | A | 1.45 | A2 | 4 | A |
| EX7 | T-A7 | 145 | A | 215 | A | 1.51 | A2 | 8 | A |
| EX8 | T-A8 | 150 | A | 220 | A | 1.81 | A2 | 9 | A |
| EX9 | T-A9 | 140 | A | 210 | A | 1.45 | A2 | 6 | A |
| EX10 | T-A10 | 135 | A | 205 | A | 1.51 | A2 | 5 | A |
| EX11 | T-A11 | 140 | A | 210 | A | 1.76 | A2 | 4 | A |
| EX12 | T-A12 | 130 | A | 205 | A | 1.46 | A2 | 5 | A |
| EX13 | T-A13 | 145 | A | 215 | A | 1.66 | A1 | 2 | A |
| EX14 | T-A14 | 135 | A | 205 | A | 1.67 | A1 | 8 | A |
| EX15 | T-A15 | 140 | A | 215 | A | 1.48 | A2 | 2 | A |
| EX16 | T-A16 | 130 | A | 210 | A | 1.49 | A2 | 6 | A |
| EX17 | T-A17 | 150 | A | 220 | A | 1.52 | A2 | 4 | A |
| EX18 | T-A18 | 140 | A | 205 | A | 1.53 | A2 | 10 | A |
| EX19 | T-A19 | 140 | A | 215 | A | 1.52 | A2 | 3 | A |
| EX20 | T-A20 | 130 | A | 205 | A | 1.54 | A2 | 8 | A |
| EX21 | T-A21 | 135 | A | 210 | A | 1.47 | A2 | 5 | A |
| EX22 | T-A22 | 135 | A | 205 | A | 1.46 | A2 | 9 | A |

Table 8 is as follows. “CEX1” indicates Comparative Example 1. “CEX2” indicates Comparative Example 2. “CEX3” indicates Comparative Example 3. “CEX4” indicates Comparative Example 4. “CEX5” indicates Comparative Example 5. “CEX6” indicates Comparative Example 6. “CEX7” indicates Comparative Example 7. “CEX8” indicates Comparative Example 8. “CEX9” indicates Comparative Example 9. “CEX10” indicates Comparative Example 10. “CEX11” indicates Comparative Example 11. “CEX12” indicates Comparative Example 12. “CEX13” indicates Comparative Example 13. “CEX14” indicates Comparative Example 14. “CEX15” indicates Comparative Example 15. “CEX16” indicates Comparative Example 16.

TABLE 8

| | | Minimum fixing | | Maximum fixing | | Color | | Heat-resistant | |
|---|---|---|---|---|---|---|---|---|---|
| | | temperature | | temperature | | development | | storage stability | |
| | | Value | Determi- | Value | Determi- | | Determi- | Value | Determi- |
| | Toner | [° C.] | nation | [° C.] | nation | Value | nation | [%] | nation |
| CEX1 | T-B1 | 160 | B | 215 | A | 1.80 | A1 | 7 | A |
| CEX2 | T-B2 | 135 | A | 205 | A | 1.52 | B1 | 5 | A |
| CEX3 | T-B3 | 155 | B | 210 | A | 1.68 | A2 | 4 | A |
| CEX4 | T-B4 | 130 | A | 205 | A | 1.40 | B2 | 6 | A |
| CEX5 | T-B5 | 155 | B | 220 | A | 1.83 | A2 | 8 | A |
| CEX6 | T-B6 | 140 | A | 210 | A | 1.41 | B2 | 4 | A |
| CEX7 | T-B7 | 155 | B | 210 | A | 1.78 | A2 | 5 | A |
| CEX8 | T-B8 | 130 | A | 205 | A | 1.42 | B2 | 3 | A |
| CEX9 | T-B9 | 160 | B | 220 | A | 1.66 | A1 | 2 | A |
| CEX10 | T-B10 | 130 | A | 200 | B | 1.64 | A1 | 12 | B |
| CEX11 | T-B11 | 155 | B | 215 | A | 1.46 | A2 | 3 | A |
| CEX12 | T-B12 | 125 | A | 195 | B | 1.48 | A2 | 11 | B |
| CEX13 | T-B13 | 165 | C | 220 | A | 1.52 | A2 | 5 | A |
| CEX14 | T-B14 | 135 | A | 200 | B | 1.54 | A2 | 18 | B |
| CEX15 | T-B15 | 155 | B | 215 | A | 1.52 | A2 | 4 | A |
| CEX16 | T-B16 | 125 | A | 195 | B | 1.51 | A2 | 14 | B |

In Tables 7 and 8, “value” means “evaluation value”.

As shown in Table 4, the contents of the colorants in the toners (T-B1), (T-B3), (T-B5) and (T-B7) were greater than 17.1 parts by mass with respect to 100.0 parts by mass of the amorphous polyester resin. As shown in Table 8, the evaluations for the minimum fixing temperatures of the toners (T-B1), (T-B3), (T-B5) and (T-B7) were unsatisfactory.

As shown in Table 4, the contents of the colorants in the toners (T-B2), (T-B4), (T-B6) and (T-B8) were less than 11.5 parts by mass with respect to 100.0 parts by mass of the amorphous polyester resin. As shown in Table 8, the evaluations for the color development of the toners (T-B2), (T-B4), (T-B6) and (T-B8) were unsatisfactory.

As shown in Table 6, the shell layer coverage ratios of the toners (T-B9), (T-B11), (T-B13) and (T-B15) were greater than 60%. As shown in Table 8, the evaluations for the minimum fixing temperature of the toners (T-B9), (T-B11), (T-B13) and (T-B15) were unsatisfactory or particularly unsatisfactory.

As shown in Table 6, the shell layer coverage ratios of the toners (T-B10), (T-B12), (T-B14) and (T-B16) were less than 30%. As shown in Table 8, all the evaluations for the maximum fixing temperature and the evaluations for the heat-resistant storage stability of the toners (T-B10), (T-B12), (T-B14) and (T-B16) were unsatisfactory.

On the other hand, as shown in Table 3, the contents of the colorants in the toners (T-A1) to (T-A22) were equal to or greater than 11.5 parts by mass but equal to or less than 17.1 parts by mass with respect to 100.0 parts by mass of the amorphous polyester resin. As shown in Table 5, the shell layer coverage ratios of the toners (T-A1) to (T-A22) were equal to or greater than 30% but equal to or less than 60%. As shown in Table 7, all the evaluations for the minimum fixing temperature, the evaluations for the maximum fixing temperature, the evaluations for the color development and the evaluations for the heat-resistant storage of the toners (T-A1) to (T-A22) were satisfactory.

Hence, the toner in the present disclosure including the toners (T-A1) to (T-A22) is determined to be able to form an image of satisfactory color development even with a small amount of toner, and to be excellent in low-temperature fixability, hot offset resistance and heat-resistant storage stability.

Therefore, the toner in the present disclosure can form an image of satisfactory color development even with a small amount of toner, and is excellent in low-temperature fixability, hot offset resistance and heat-resistant storage stability

The toner in the present disclosure can be used for forming an image in, for example, a copying machine, a printer and a multifunctional peripheral.

What is claimed is:

1. A toner comprising:
a toner particle,
wherein the toner particle includes:
a toner core; and
a shell layer that covers a surface of the toner core,
the toner core contains:
a binding resin; and
a colorant,
the binding resin includes:
an amorphous polyester resin; and
a crystalline polyester resin,
a content of the colorant is equal to or greater than 11.5 parts by mass but equal to or less than 17.1 parts by mass with respect to 100.0 parts by mass of the amorphous polyester resin and
an area ratio of a region covered by the shell layer to a surface region of the toner core is equal to or greater than 30% but equal to or less than 60%.

2. The toner according to claim 1,
wherein the shell layer contains two resins.

3. The toner according to claim 1,
wherein the shell layer contains a cross-linked styrene-acrylic resin and a non-cross-linked styrene-acrylic resin.

4. The toner according to claim 1,
wherein the shell layer contains:
a styrene-acrylic resin including a cyano group; and
a styrene-acrylic resin including a quaternary ammonium base.
